(19) United States
(12) Patent Application Publication
(10) Pub. No.: US 2020/0048821 A1
(43) Pub. Date: Feb. 13, 2020

(54) AUTOMATIC SHUTOFF DEVICE FOR A CLOTHES DRYER

(71) Applicant: Malcolm Armstrong, Brockville (CA)

(72) Inventor: Malcolm Armstrong, Brockville (CA)

(21) Appl. No.: 16/653,528

(22) Filed: Oct. 15, 2019

Related U.S. Application Data
(63) Continuation-in-part of application No. 12/941,163, filed on Feb. 13, 2011, now Pat. No. 10,443,938.

(51) Int. Cl. D06F 58/28; H01H 47/00

(52) U.S. Cl. CPC D06F 58/28; H01H 47/002; D06F 2058/2819; H01H 2231/012; D06F 2058/2803; D06F 2058/2829; D06F 2058/2854; D06F 2058/289

(57) ABSTRACT

A sensor is provided that is applicable to new and old clothes dryers, including clothes dryers that have a built-in moisture sensor, because the sensor of the present invention also measures the humidity which has proven to be far more accurate. The retrofit moisture and humidity sensor can be installed in a clothes dryer and can be used to reduce energy consumption for gas and electric clothes dryers. The sensor communicates with a receiver device that shuts off the power to the clothes dryer when the items in the clothes dryer are sufficiently dry as measured by the sensor. An advantage of this inexpensive power saving device is that it does not require any mechanical alterations to the clothes dryer.

### RELATED APPLICATION DATA

This application is a continuation-in-part of U.S. patent application Ser. No. 12/941,163, filed Feb. 13, 2011, titled “Retrofit Moisture and Humidity Sensor and Automatic Shutoff Device for Clothes Dryers,” which is incorporated herein by reference in its entirety.

### FIELD OF THE INVENTION

The present invention generally relates to the field of devices for reducing energy consumption for gas and electric domestic or industrial clothes dryers. In particular, the present invention is directed to an Automatic Shutoff Device for a Clothes Dryer.

### BACKGROUND

While there are clothes dryers in the market that have built-in moisture sensor(s), many models in use do not have such sensors, and for the dryers that do include such sensors, they tend to be ineffective because they don't measure humidity and thus under-dry or over-dry the clothes. A typical clothes dryer is a large appliance for drying clothes, bedding, towels, and other linens. Moisture is removed from clothes by a combination of air, heat, and motion. Gas and electric dyers differ mainly in the heat source. Both gas and electric models use a motor to turn a drive belt. The drive belt revolves the drum which holds the clothing. A blower directs air past the heat source and into the drum where it draws lint and moisture from the fabrics through a lint screen and out an exhaust duct. Appliance controls regulate the options, such as temperature and drying time. Some machines use mechanical timers while others rely on digital electronics.

Clothes dryers constitute one of the most energy intensive appliances, yet clothes dryers are one of the few appliances that have not demonstrated significant reduction of energy consumption in recent years via technological improvements. One significant waste of energy caused by clothes dryers is over drying. Although some dryers come with built-in moisture sensors, many do not measure the humidity. Therefore, there is a need for a retrofit moisture and humidity sensor and automatic shutoff device for existing clothes dryers.

### SUMMARY OF THE DISCLOSURE

An automatic shutoff device for a clothes dryer is provided that includes a sensor device that is removably placeable in an exhaust port of the clothes dryer by a user of the clothes dryer. The sensor device includes a sensor for detecting a humidity level of air exiting the drum of the clothes dryer, a communication device, and a power source in electrical contact with the communication device. A receiver device is operable to reversibly interrupt a flow of electrical power between the clothes dryer and an external electrical power source when the receiver device is in electrical contact with a power cord of the clothes dryer and with the external electrical power source, the receiver device being configured to receive a signal from the communication device of the sensor device. A wire connects the sensor device and the receiver device such that communications can be sent from the sensor device to the receiver device. When the clothes dryer is in use and the humidity level detected by the sensor device is reduced to a predetermined humidity level, the communication device sends the signal through the wire to the receiver to interrupt the flow of electrical power from the external electrical power source to the clothes dryer.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a perspective view of a sensor in accordance with an embodiment of the present invention;

FIG. 2 is a perspective view of a clothes dryer system with the sensor of FIG. 1 installed;

FIG. 3 depicts a receiver in accordance with an embodiment of the present invention;

FIG. 4 is a perspective view of the clothes dryer system with the receiver connected to an on/off switch; and

FIG. 5 is a perspective view of a shutoff system for a clothes dryer in accordance with another embodiment of the present invention.

### DESCRIPTION OF THE DISCLOSURE

An automatic shutoff device of the present invention is applicable to new and old clothes dryers, including clothes dryers that have a moisture sensor built-in because the automatic shutoff device may also measures the humidity. Use of an automatic shutoff device as described herein prevents over-drying as well as reducing unnecessary energy consumption. Measuring the humidity, as opposed to only moisture, is a more accurate way to detect whether the items in the dyer are in fact dry. The automatic shutoff device includes a humidity detecting apparatus that can be placed inside the drum, on the drum, or in the exhaust area of the inside of the clothes dryer, and serves to communicate to a receiver device. The receiver may be plugged into an electrical outlet and the clothes dryer is plugged into the receiver. When the level of humidity detected by the sensor reaches a predetermined level in the clothes dryer, the sensor communicates to the receiver, which then cuts the power to the clothes dryer. In addition, the sensor or sensors may include a temperature gage and/or a smoke detector. The temperature gage can be used for determining if excessive heat is building in the dryer, in which case a signal may be sent to the receiver to turn off the dryer. Similarly, the smoke detector can be used to detect smoke from a possible fire in the dryer, and if smoke if detected a signal may be sent to the receiver to turn off the dryer.

In an exemplary embodiment, an automatic shutoff device for a clothes dryer shown includes a humidity sensor, a receiver that cuts the power to the clothes dryer when the sensor sends a signal, and an on/off switch that is connected to the receiver and attached to the clothes dryer.

The humidity sensor detects the level of the humidity of the items inside the clothes dryer. The humidity sensor is configured to communicate with the receiver via any suitable method, including wired or wirelessly. In either case, the connection between the sensor and the receiver is preferably easily reestablished so that if the sensor needed to be replaced a user could replace the sensor without replacing the receiver. The humidity sensor can be attached to the drum of the clothes dryer, anywhere inside the clothes dryer (e.g., on the inside door or the back of the inside of the clothes dryer), or near or in the exhaust port. The humidity sensor may also be placed along with the items in the clothes dryer in the same way one could place a tennis ball inside a clothes dryer.

The humidity sensor may either be attached in any suitable manner, including magnetically to the inside of the clothes dryer or the humidity sensor can be in the shape of a ball and freely move inside the clothes dryer as opposed to being otherwise attached to the inside of the clothes dryer.

The humidity sensor may be battery powered and include a flashing LED light to indicate that it is working. The humidity sensor is preferably insulated to protect the battery from the heat of the dryer.

The humidity sensor has different levels of dryness that can be selected. A switch or other suitable mechanism on the humidity sensor allows for the selection of a desired dryness level. The humidity sensor has an on/off switch to conserve its battery life or if the user does not want to use the humidity sensor for a particular dryer operation. When not in use, the humidity sensor will shut-off automatically after a certain time.

The receiver is plugged into an electrical outlet. The clothes dryer is then plugged into the receiver. The receiver may be a small box (for example, approximately 6 inches by 6 inches). The receiver cuts the power to the clothes dryer when the selected humidity/moisture level is detected similar to how a timer is able to cut the power to a table lamp. For those clothes dryers that are gas powered, the receiver would be constructed in a different manner since a gas dryer typically uses 120V and an electric typically uses 240V. The receiver may also be configured to allow the user and/or utility companies to monitor electricity use or allow the user to operate the dryer remotely.

Optionally, a wire (which may be preferably about six feet in length) is attached to the receiver and has a user access device on the other end that includes power on/off switch, which may be attached to the dryer at a convenient location. The power on/off switch can be used to override the receiver's ability to turn the power to the dryer on or off. Since most electrical outlets for clothes dryers are not easily accessible, the wire with its power on/off switch allows a user to override the receiver without having to reach the outlet to which the receiver is attached. The on/off switch may be attached to the dryer in any suitable manner, including magnetically to the outside front or on the side of the clothes dryer. This on/off switch can also serve the purpose of turning the power back (after it has been automatically shut off) on so a new load of laundry can be placed in the clothes dryer. In addition, the user access device may also include a knob, screen, lever, or other suitable mechanism that allows for the selection of a desired dryness level, which adjusts the dryness level of the sensor. The user access device may also include a delay start button, which, for example, allow the dryer to start in a selected amount of time, such as one hour. In operation, the dryer would first be started using the timed dry option of the dryer if available and then the user would press the delay start button. An LED light may also be included on the user access device to indicate the detection of high heat or smoke by the sensor.

As a result of the humidity sensor, items in a clothes dryer will not be over-dried, which will result in less energy consumption by the dryer.

The automatic shutoff system includes one or more of the following advantages (a) reusable; (b) portable/detachable (i.e., the product can be easily removed and used on another clothes dryer; (c) versatile (i.e., can be used in most clothes dryer); (d) inexpensive to buy; (e) saves wear-and-tear on clothes dryers due to less drying time; (f) less wear-and-tear on clothes by preventing over-drying; (g) reduction in greenhouse gas emissions as less drying time means less energy required; (h) does not require a technician to install it.

Although moisture sensing technology is currently available in some newer clothes dryers that have a built-in moisture sensor, the automatic shutoff system described herein has the added advantage of not only detecting the moisture but also the humidity. Humidity is a more accurate way of determining when items are dry and thereby conserves more energy while not prematurely shutting of the dryer. The humidity sensor is portable and thus allowing the humidity sensor to be used in any clothes dryer. Like existing moisture sensors, the humidity sensor for this invention will be able to detect and gage the level of moisture and humidity of particular items being dried in a clothes dryer.

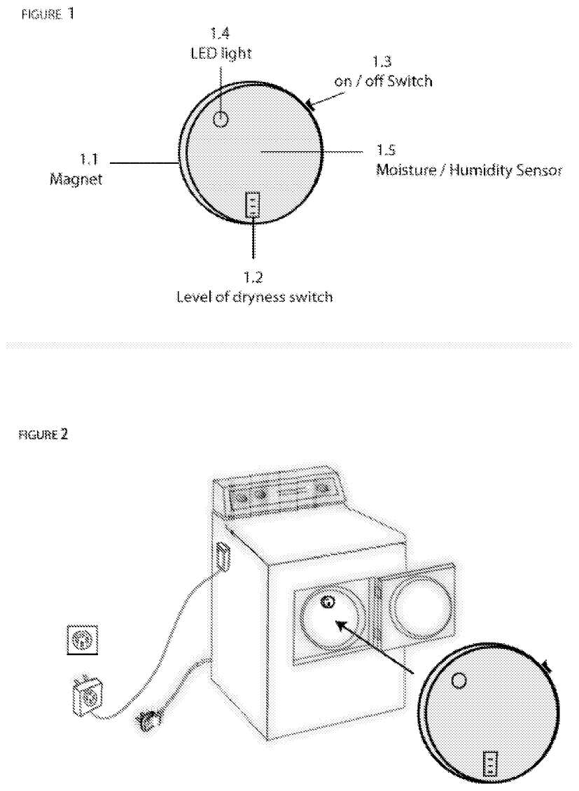

A humidity sensor, such as the sensor shown in FIG. 1, may include five components: an attachment mechanism, such as magnet 1.1, a level of dryness selector 1.2, an on/off switch 1.3, an indicator, such as LED light 1.4, and a humidity detector 1.5. If a magnet is used, the sensor can be attached anywhere in the clothes dryer (as shown in FIG. 2). The level of dryness selector allows the user to choose the level of dryness.

The humidity sensor can communicate to the receiver wirelessly or through a wired connection, which in-turn can cuts the power to the clothes dryer once the selected level of dryness is detected by the sensor.

Referring to FIG. 3, the clothes dryer electric cord 3.3 is plugged into the receiver 3.2, which is plugged into an appropriate outlet, such as 240V outlet 3.1. The receiver serves the purpose of cutting the power to the clothes dryer once the humidity sensor selected level of dryness.

There can be more than one humidity sensor used during any given load of items being dried in the clothes dryer.

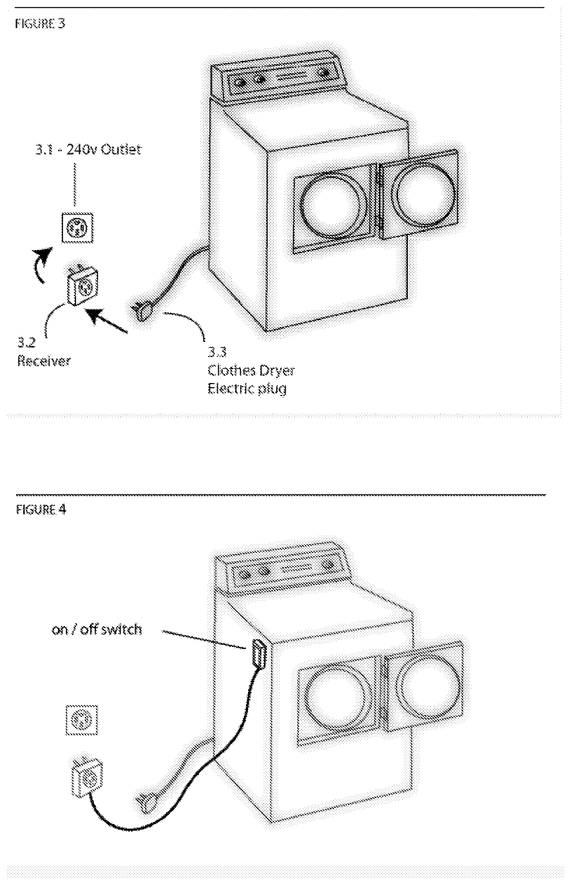

Since the receiver will be located wherever the outlet is (which is normally behind the clothes dryer), the receiver may be difficult to reach. In order to override the receiver and to reinstate the power to the clothes dryer, a convenient switch may be placed on the dryer and connected to the receiver (as shown in FIG. 4). For example, a 6 ft wire can run from the receiver to an on/off switch. The switch can have a small magnet attached to it so the user can place the switch on the clothes dryer wherever is convenient. Once the receiver cuts the power to the clothes dryer, the on/off switch can be used to conveniently turn the power back on.

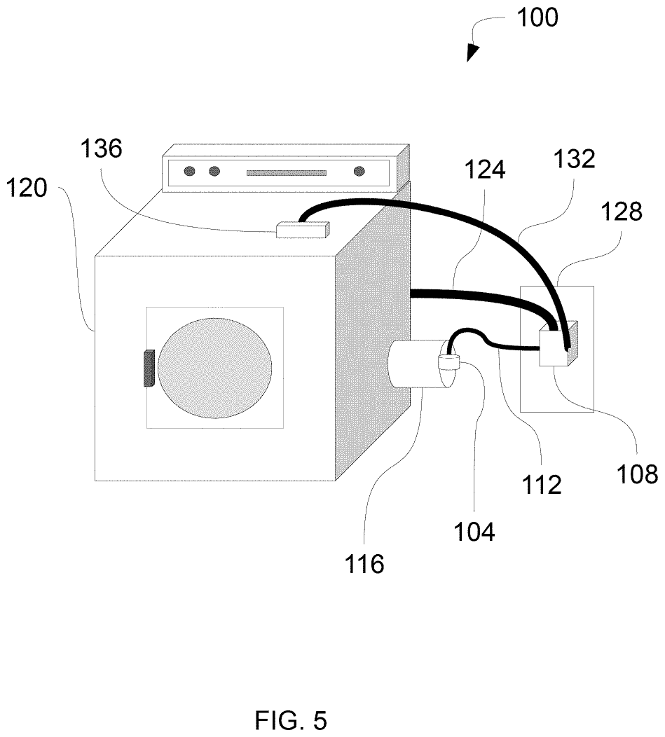

Turning to FIG. 5, in another embodiment, an automatic dryer shutoff system 100 is similar in function and advantages as described above and includes a sensor 104, a receiver 108, and a wire 112, in which wire 112 connects sensor 104 to receiver 108. As shown in FIG. 5, sensor 104 may be attached in or near an exhaust port/vent 116 or dryer 120. Dryer cord 124 is connected to receiver 108, which is connected to an outlet 128 when in use. A user access device 136 may be attached to dryer 120 at a convenient location, such as on the top of dryer 120 as shown in FIG. 5, and connected to receiver 108 via a wire 132

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. An automatic shutoff device for a clothes dryer, the device consisting of:
a sensor device being removably placeable in an exhaust port of the clothes dryer by a user of the clothes dryer, the sensor device comprising:
a sensor for detecting a humidity level of air exiting the drum of the clothes dryer,
a communication device, and
a power source in electrical contact with the communication device;
a receiver device operable to reversibly interrupt a flow of electrical power between the clothes dryer and an external electrical power source when the receiver device is in electrical contact with a power cord of the clothes dryer and with the external electrical power source, the receiver device being configured to receive a signal from the communication device of the sensor device; and
a wire connecting the sensor device and the receiver device such that communications can be sent from the sensor device to the receiver device,
wherein when the clothes dryer is in use and the humidity level detected by the sensor device is reduced to a predetermined humidity level, the communication device sends the signal through the wire to the receiver to interrupt the flow of electrical power from the external electrical power source to the clothes dryer.

2. The automatic shutoff device of claim 1, wherein the sensor device further includes a dryness level selector.

3. The automatic shutoff device of claim 1, further including a user access device configured to be attached to the clothes dryer and a second wire connecting the user access device to the receiver device, wherein the user access device includes a user access dryness level selector and an on/off switch for restoring power to the clothes dryer through the receiver device.

4. The automatic shutoff device of claim 3, wherein the dryness level selector is controlled through the user access device.

5. The automatic shutoff device of claim 1, wherein the sensor further detects temperature.

6. The automatic shutoff device of claim 5, wherein the sensor further detects smoke.

7. The automatic shutoff device of claim 6, wherein when the temperature detected by the sensor device reaches a predetermined high temperature, the communication device sends the signal through the wire to the receiver to interrupt the flow of electrical power from the external electrical power source to the clothes dryer.

8. The automatic shutoff device of claim 7, wherein when the smoke detected by the sensor device reaches a predetermined smoke level, the communication device sends the signal through the wire to the receiver to interrupt the flow of electrical power from the external electrical power source to the clothes dryer.
